(19) United States
(12) Patent Application Publication
(10) Pub. No.: US 2007/0151461 A1
(43) Pub. Date: Jul. 5, 2007

(54) Beverage infusion making apparatus

(76) Inventors: John Thomas Edmark, Stanford, CA (US); Christopher Miksovsky, San Francisco, CA (US)

Correspondence Address: SEYFARTH SHAW LLP, 131 S. DEARBORN ST., SUITE2400, CHICAGO, IL, 60603-5803, US

(21) Appl. No.: 11/636,137

(22) Filed: Dec. 8, 2006

Related U.S. Application Data
(60) Provisional application No. 60/749,532, filed on Dec. 12, 2005.

(51) Int. Cl. A47J 31/44

(52) U.S. Cl. 99/279

(57) ABSTRACT

A plunger filter infusion device comprises a container, a plunger having a resilient plunger head slidable within the container, and an insert plate connected to a long shaft placeable in the base of the container. The insert is placed in the container, infusible material is placed in the container, heated water is poured into the container and the plunger is slid into the container with the shaft of the insert sliding within the hollow central tube of the plunger. The end of the insert shaft becomes releasably connected to the handle via a locking mechanism in the handle. The infusible material is thus confined between the plunger head and the insert plate. The plunger and insert can be removed as one unit allowing clean and simple disposal of the infusible material.

### CROSS-REFERENCE TO RELATED APPLICATIONS

The present application claims priority to and benefit of U.S. Provisional Application Ser. No. 60/749,532, to Miksovsky, et al., titled “Beverage Infusion Making Apparatus,” filed Dec. 12, 2005, the entirety of which is incorporated herein.

### FIELD OF THE INVENTION

The present invention generally relates to the field of beverage infusion making apparatus. More particularly, the present invention relates to the field of brewing apparatus for brewing ground coffee beans, tea, or other beverages.

### BACKGROUND

Brewing apparatus, such as a French Press or coffee press, is well known in the prior art. The French press or coffee press has become a preferred way of brewing coffee among professional coffee tasters and the coffee drinking public in general. The coffee press is a relatively simple device comprising a pitcher (typically made of glass), a lid with a central hole, and a plunger fitted with a fine mesh screen or filter which is operated through the hole in the lid. In use, the ground coffee is placed in the pitcher and boiling water is added. The top is placed on the pitcher with the plunger withdrawn so that the filter is above the grounds and the water, allowing the coffee to brew. After a few minutes, the plunger is pushed down towards the bottom of the pitcher, so that the coffee grounds are separated from the liquid. The coffee is then transferred out from the French press and into a drinking cup for the user to drink the coffee.

While the known arrangement of a coffee press has the ability to make superior coffee, a problem arises when it is desired to wash the container after use. At that stage the plunger is removed and the coffee grounds are poured from the container into a sink or a bin. The operation is generally very messy and it is usually necessary to flush residual coffee grounds down the sink with copious quantities of water which is time consuming and wasteful. Furthermore, plumbers advise against pouring used coffee grounds down a sink drain because it creates the likelihood of a clog, which can be expensive and time consuming to remove.

As a consequence, there has been a long felt need for a brewed beverage maker that is designed for easier and more efficient cleaning.

U.S. Pat. No. 5,979,299 to Hornsby et al. discloses a beverage infusion making apparatus that attempts to address the need of a more easily cleanable coffee press. Hornsby employs a cup shaped insert within which to collect the coffee grounds. Unfortunately, this solution has numerous drawbacks. Hornsby's design does not guarantee a positive locking effect between the plunger and the cup shaped insert, making it possible to drop the cup and contained grounds before it is desired to do so. Furthermore, Hornsby discloses that the cup insert may be perforated. Any holes or perforations in the cup insert will inevitably clog with coffee grounds, requiring time and energy by the user to clean out. Finally, Hornsby's design does not discuss how exactly the cup insert is removed from the plunger. Presumably, the user must grab the cup insert full of wet, hot coffee grounds and physically separate it from the plunger, making it likely to get the hand grabbing the cup insert both wet and covered with coffee grounds, and possibly burnt.

Thus, there remains a need for a for a brewed beverage maker that is designed for easier and more efficient cleaning.

### SUMMARY

According to the present invention there is provided a beverage infuser comprising a beverage container, a plunger having a perforated head slidable within the container and a preferably disc-shaped insert that is connected to a shaft in a “T”-shaped configuration. The plunger is connected via a hollow tube to a handle in which resides a locking mechanism. The shaft of the insert is slidable within the tube of the plunger and is releasably attached to the locking mechanism in the handle. In this arrangement, the insert is placed in the container, and then the infusible material, for example uninfused coffee grounds, are then placed on top of the disc insert. Hot water is then poured in and, after the infusion period, the grounds are confined between the insert and the plunger by sliding the plunger into the container thus engaging the locking mechanism in the handle with the shaft of the insert. When it is desired to dispose of the coffee grounds, the plunger and insert are withdrawn simultaneously from the container, with the grounds sandwiched between the plunger and the insert. The coffee grounds may then be easily and cleanly disposed of by tapping, shaking or otherwise disturbing the grounds “sandwich” such that the grounds fall into any suitable container. Note that because the insert does not have vertical sidewalls, the grounds may be shaken off simply by tipping the disc/grounds/plunger sandwich to the side and does not require any handling of the wet, hot grounds by one's hand. Also note that the insert is of a solid construction and does not have any cavities to trap the coffee grounds. Once the grounds have been dispensed into a suitable bin, the user can quickly rinse off any residual grounds in a sink. Once the few remaining residual grounds are rinsed off (which also cools the apparatus), the user can depress a catch on the handle to release the insert from the handle. The insert is then slid out from the plunger tube and the brewing process may begin anew.

### BRIEF DESCRIPTION OF THE DRAWINGS

For a better understanding of the invention as well as other objects and further features thereof, reference is made to the following detailed description to be read in conjunction with the accompanying drawings wherein:

FIG. 1 is a perspective view of a beverage infusion making apparatus in accordance with the invention.

FIG. 2 is a perspective view of the insert of the invention.

FIG. 3 is a front view of the insert of the invention.

FIG. 4 is a front view of the insert placed into a suitable container.

FIG. 5 is a perspective cross sectional view showing the container, insert, and infusible material such as coffee grounds.

FIG. 6 is a perspective view of the plunger of the invention.

FIG. 7 is a front cross-sectional view of the plunger of the invention.

FIG. 8 is a perspective cross sectional view of the invention prior to insertion of the plunger with lid and handle into the container.

FIG. 9 is a perspective cross sectional view of the invention after insertion of the plunger with lid and handle into the container, with the shaft of the insert now affixed to the locking mechanism in the handle.

FIG. 10 is detail cross sectional view of the invention showing one embodiment of the locking mechanism.

FIG. 11 is a perspective cross sectional view of the invention after removal of the plunger and insert from the container.

FIG. 12 is a perspective view of the invention showing the infusible material being deposited into a suitable bin.

### DETAILED DESCRIPTION

For a better understanding of the invention as well as other objects and further features thereof, reference is made to the following detailed description to be read in conjunction with the accompanying drawings wherein:

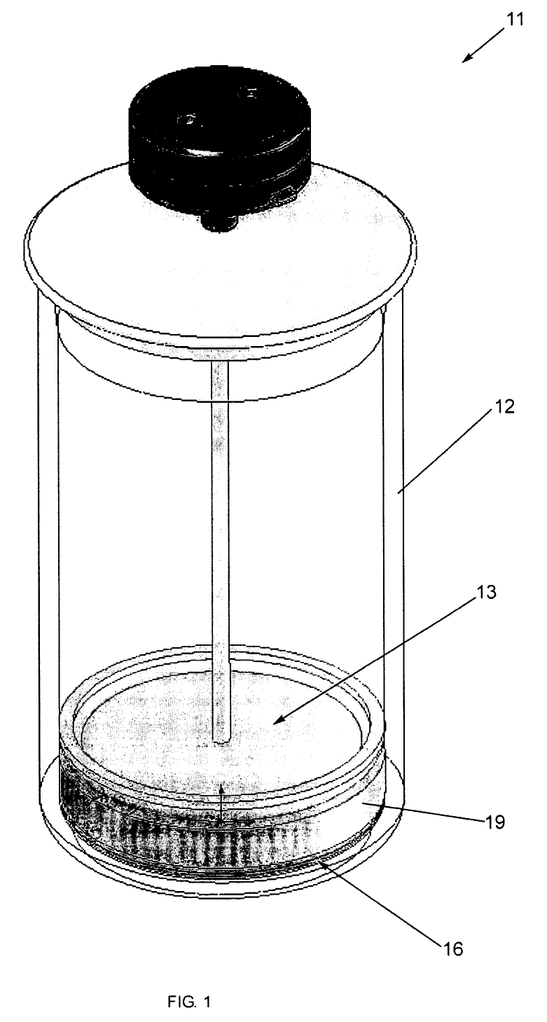

FIG. 1 is a perspective view of beverage infusion making apparatus 11 constructed in accordance with the invention. The beverage infusion making apparatus 11 comprises a container 12 such as a conventional coffee press beverage container made of glass, plastic, or other suitable material having a circular cross section. A plunger 13 (for example a plunge filter) is shaped to fit inside the container 12. An insert 16 is shaped to fit inside the container 12. The insert 16 is shaped to slidably fit in the container 12 and has a circular perimeter to fit closely inside the container. Infusible material 19 such as coffee grounds or tea leaves are compressed between the depressed plunger 13 and the insert 16.

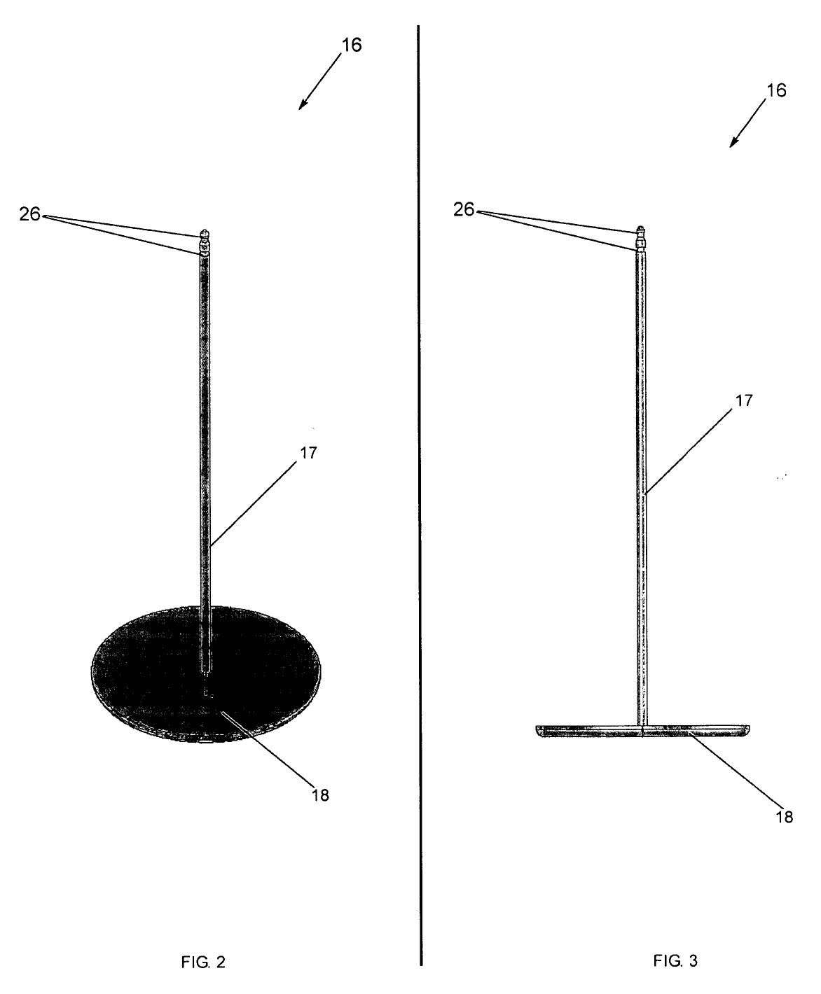

FIG. 2 is a perspective view of the insert 16 of the invention. The insert 16 comprises a circular plate 18 and a shaft 17. The plate 18 and shaft 17 may be constructed as a single piece of plastic, metal or other suitable material, or the plate 18 and shaft 17 may be fabricated as separate components (made of plastic, metal or other suitable material) and secured together either mechanically, with an adhesive, or other means. In the present embodiment, the shaft 17 of the inset 16 features one or more detents 26 that are used to secure the insert 16 to the handle 21 and plunger 13 of the invention.

FIG. 3 is a front view of the insert 16 of the invention to clarify the T-shaped orientation of the plate 18 and shaft 17.

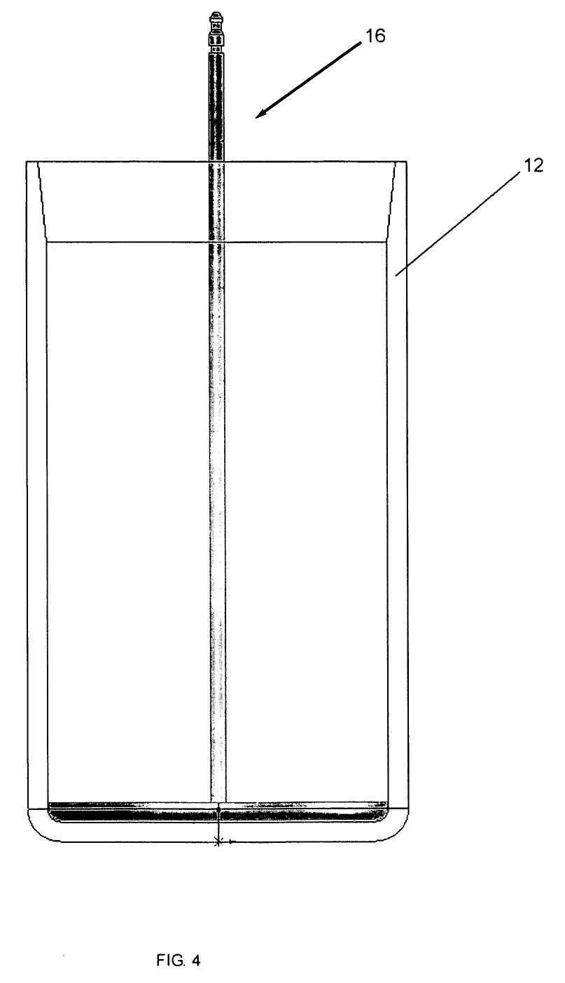

FIG. 4 is a front view of the insert 16 placed into a suitable container 12. The container 12 is preferably circular in cross section and the insert 16 is sized to be close in size to the cross section of the container 12 while still permitting enough gap to permit an easy insertion and removal of the insert 16 within the container 12.

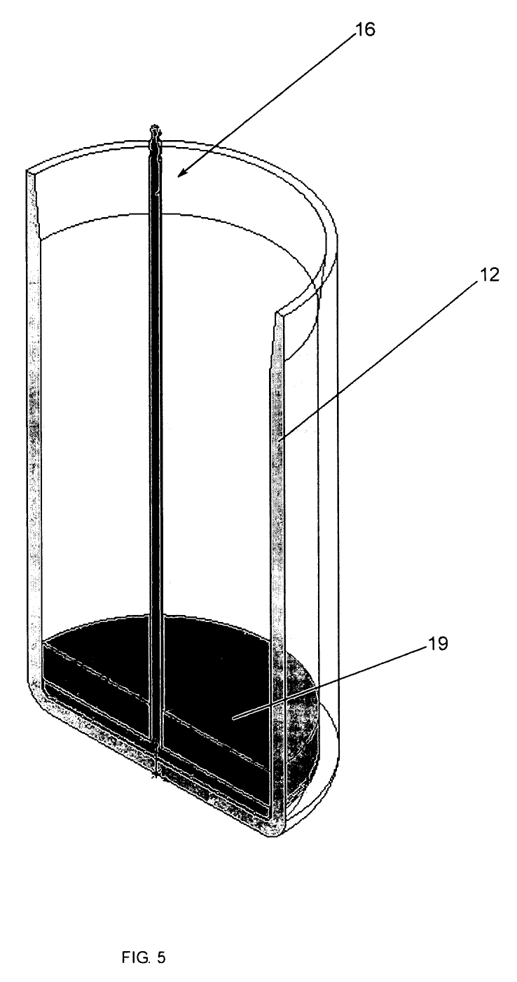

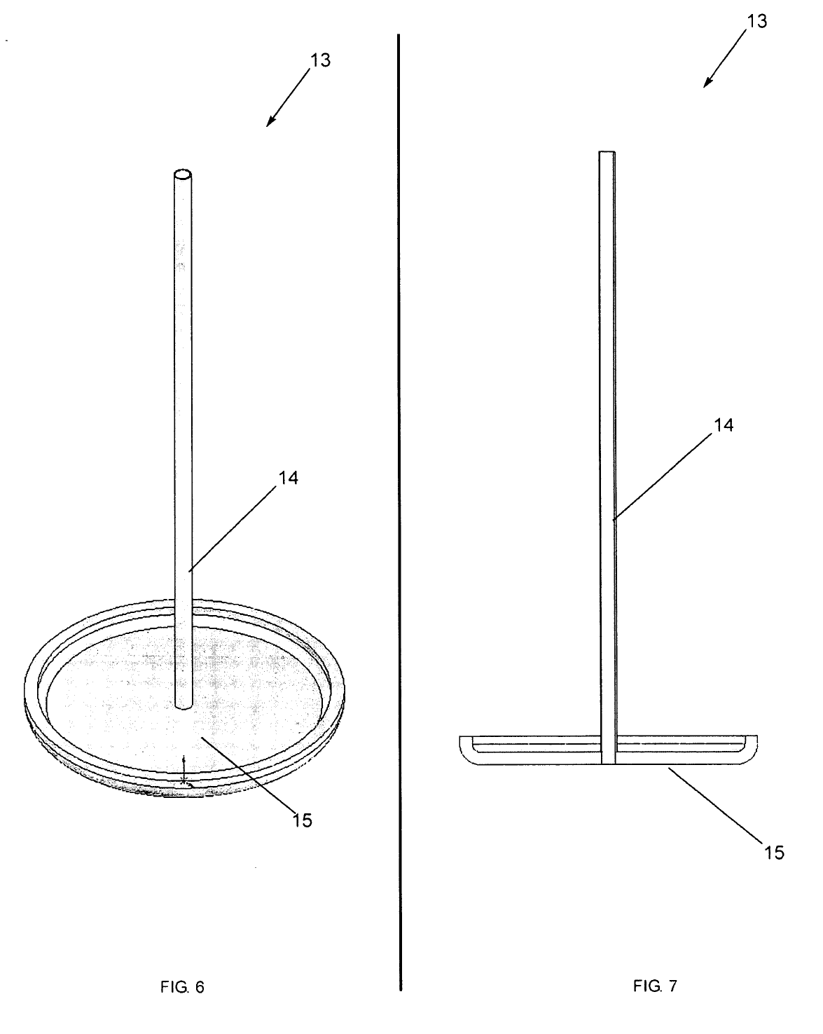

FIG. 5 is a perspective cross sectional view showing the container 12, insert 16, and infusible material 19 such as coffee grounds. The insert 16 is first placed into the container 12 and then the infusible material 19 is placed on top of the insert 16.

FIG. 6 is a perspective view of the plunger 13 of the invention. The plunger 13 comprises a circular head 15 and a tube 14. The head 15 and tube 14 may be constructed as a single piece of plastic, metal or other suitable material, or the head 15 and tube 14 may be fabricated as separate components (made of plastic, metal or other suitable material) and secured together either mechanically, with an adhesive, or other means. The head 15 is shown diagrammatically in this figure and may feature the components typically found on the head of a common coffee press (e.g. mesh screen, supporting frame, helical sealing spring running around the circumference of the head, etc.—none of these typical components are shown as they are common knowledge in the prior art).

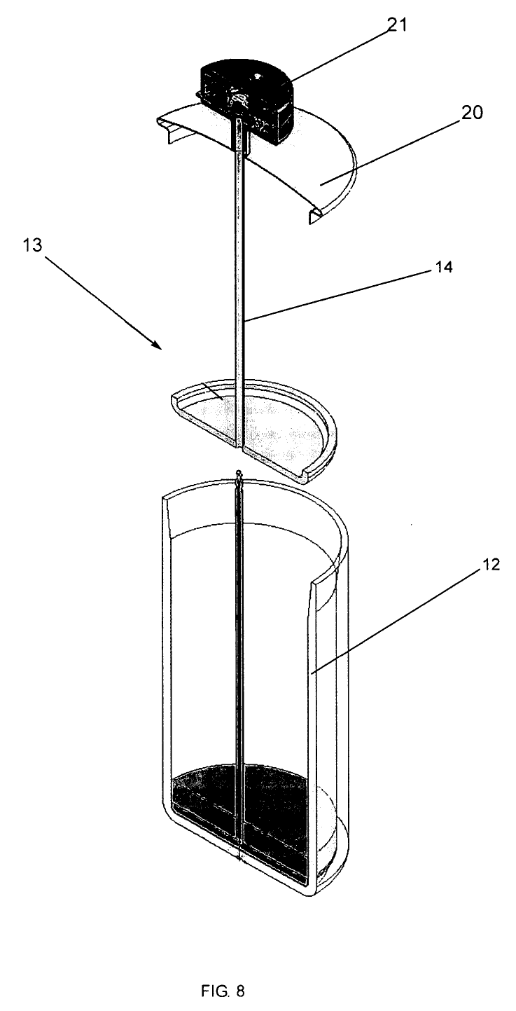

FIG. 7 is a front cross-sectional view of the plunger 13 the invention showing the hollow tube 14 and its perpendicular orientation relative to the head 15.

FIG. 8 is a perspective cross sectional view of the invention prior to insertion of the plunger 13 with lid 20 and handle 21 into the container 12. The tube 14 of the plunger 13 is secured to the handle 21 by mechanical means, adhesive, or other suitable fastening mechanism.

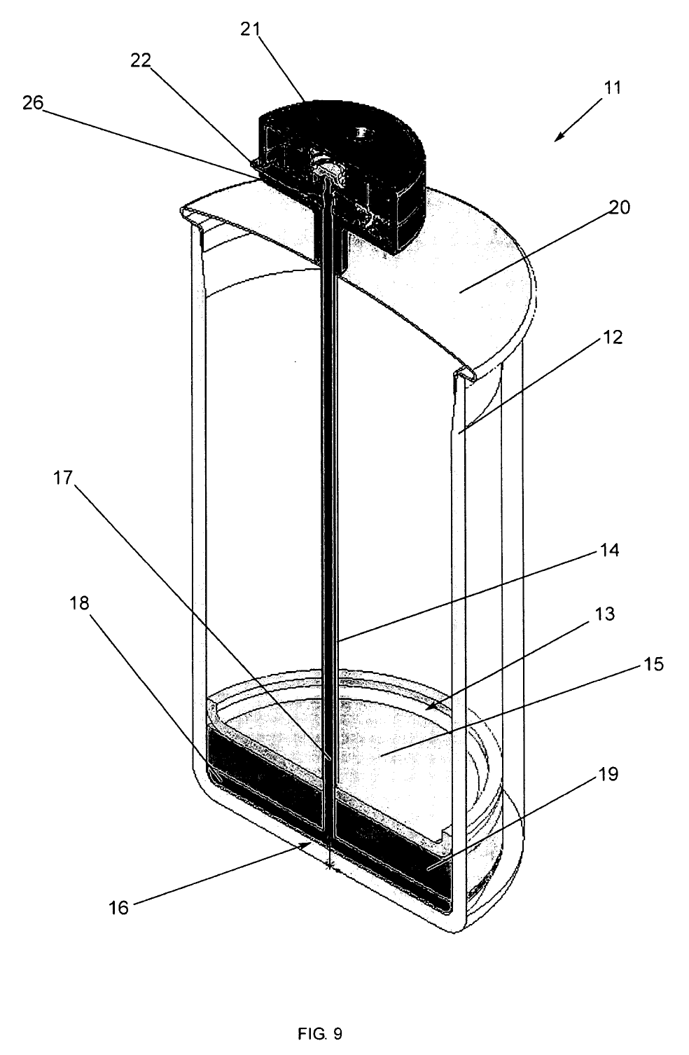

FIG. 9 is a perspective cross sectional view of the invention after insertion of the plunger 13 with lid 20 and handle 21 into the container 12. This figure clarifies the insertion of the shaft 17 of the insert 16 into the tube 14 of the plunger 13. Thusly configured, the infusible material 19 is now contained between the head 15 of the plunger 13, and the plate 18 of the insert 16. Once the plunger 13 is depressed to a sufficient depth in the container 12, the detents 26 on the shaft 17 become aligned to the catch 22 in the handle 21, thereby releasably securing the insert 13 to the handle 21 and plunger 13. A multitude of detents 26 allows the plunger 13 to be depressed to varying depths, thereby compressing the infusible material 19 as much as necessary. Complete compression of the infusible material 19 ensures maximum flavor extraction. Furthermore, any infused beverage beneath the plunger 13 is unlikely to readily be poured out. Thus, Hornsby's solution wastes valuable infused water. The present invention allows the plunger 13 to be depressed as much as necessary, thereby maximizing the amount of infused beverage that can be readily used.

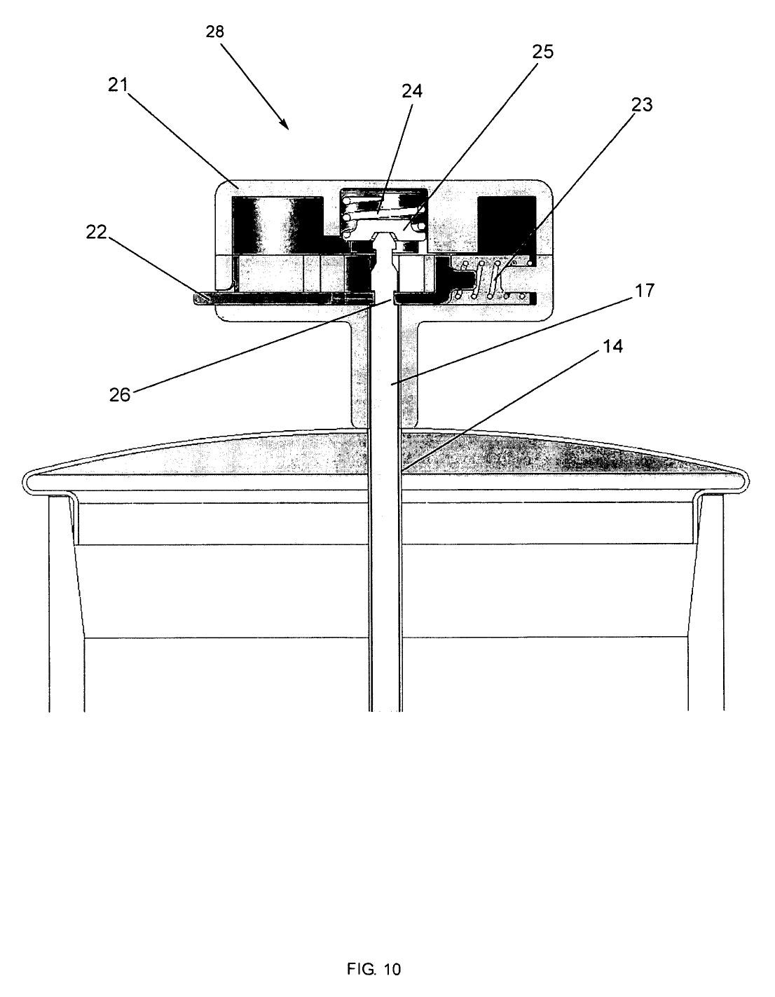

FIG. 10 is detail cross sectional view of the invention showing one embodiment of the locking mechanism 28 used to releasably secure the shaft 17 of the insert 16 to the handle 21. A catch 22 slides in a groove of the handle 21 and is inclined to one side by a horizontal spring 23. The head of the shaft 17 is rounded, beveled or otherwise configured to move the catch 22 sideways when the head of the shaft 17 contacts the catch 22 from below. The catch 22 is moved sideways by the shaft 17 until one of the detents 26 of the shaft become aligned to the catch 22. The horizontal spring 23 moves the catch 22 underneath the undercut created by the detents 26, preventing the shaft 17 from sliding downwards. The positive locking action assures a firm hold on the shaft 17 so that the user may confidently transport the infusible material 19 to a bin 27. If numerous detents 26 are featured, the handle 21 and plunger 13 may continue to be pressed downwards into the container 12, and the catch 22 will align to these subsequent detents 26. The head of the shaft contacts a centering button 25 that is in turn connected to a vertical spring 24. The vertical spring 24 is inclined to push the shaft 17 downwards but is prevented from doing so by the catch 22 aligned to the detents 26. To release the shaft 17 from the handle 21 and plunger 13, the user depresses the end of the catch 22 that protrude out from the handle 21, to overcome the force of the horizontal spring 23 and remove the catch 22 from the undercut in the shaft 17 created by the detents 26. Once the catch 22 is removed from the under cut in the shaft 17 created by the detents 26, the vertical spring 24 is free to move the shaft 17 downwards. The vertical spring 24 may have sufficient force to move the shaft 17 through the plunger tube 14 either partially or completely. This movement of the insert 16 downwards gives the user positive feedback that the insert 16 is free to be removed.

Although the present invention has been described with reference to a preferred locking mechanism 28, workers skilled in the art will recognize that changes may be made in form and detail without departing from the spirit and scope of the invention. It is the applicant's intent that the invention claimed include any design variations which incorporate a locking mechanism 28 housed in the handle 21 capable of being releasably secured to the shaft 17 of the insert 16. For example it may be preferable to incorporate the ratcheting locking mechanism typically found on a hand clamp (such as that sold by Irwin Tools called the “Quick Grip Handi Clamp”) whereby a translating bar slides through an opening in a release catch that only permits a sliding action in one direction until the catch is actuated by the user, thus freeing the bar to slide back to its original position. In another embodiment, the locking mechanism 28 may not feature any discrete detents but may be releasably coupled to the shaft with a wedging or other suitable action against the rounded surface of the shaft 17 (such as the locking mechanism found on the Irwin Tools “Quick Grip One-Handed Bar Clamps”). One skilled in the art will recognize that the components of the locking mechanism could be made from plastic, metal or other suitable material by common manufacturing processes.

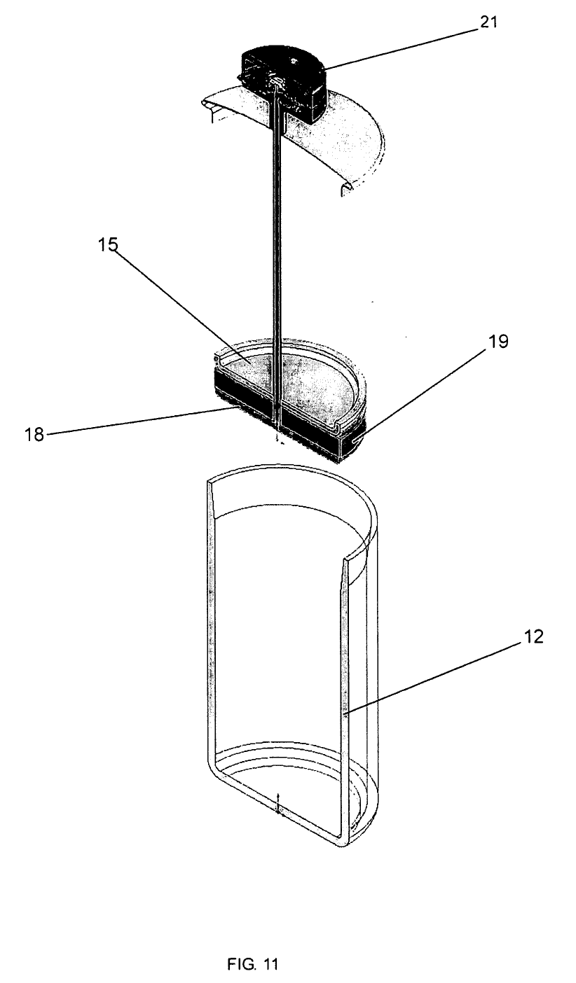

FIG. 11 is a perspective cross sectional view of the invention after removal of the plunger 13 and insert 16 from the container 12. Note that the infusible material 19 is contained between the head 15 of the plunger 13 and the plate 18 of the insert 16. The compressive action of the plunger 13 on the infusible material 19 creates a compact package which disinclines the infusible material 19 from falling off until disrupted either by shaking, tapping or other suitable action. The compression of the infusible material 19 against the interior wall of the container 12 also effectively creates a plug of material that, when removed, creates a mild vacuum in the area beneath the plug of infusible material 19. This mild vacuum serves to further leach residual water from the infusible material 19 making for a more solid and cohesive “puck” of infusible material 19. The vacuum leaches the residual water and draws it downwards moving the fluid between the periphery of the plate 18 and the inner wall of the container 12. Thus, this is effectively a way to create a non-clogging sieve.

In an alternate embodiment the shaft 17 may be hollow so as to create a direct passageway for air to enter into the volume of space created beneath the plate 18 as the plunger 13, infusible material 19 and insert 16 are drawn upwards. This access of air would lessen or eliminate the vacuum effect and could permit faster and easier removal of the plunger 13, infusible material 19 and insert 16.

In another alternate embodiment, openings may be featured in the plate 18 to allow easier passage of air into the volume of space beneath the plate 18 created as the plunger 13, infusible material 19 and insert 16 are drawn upwards. This access of air would lessen or eliminate the vacuum effect and could permit faster and easier removal of the plunger 13, infusible material 19 and insert 16.

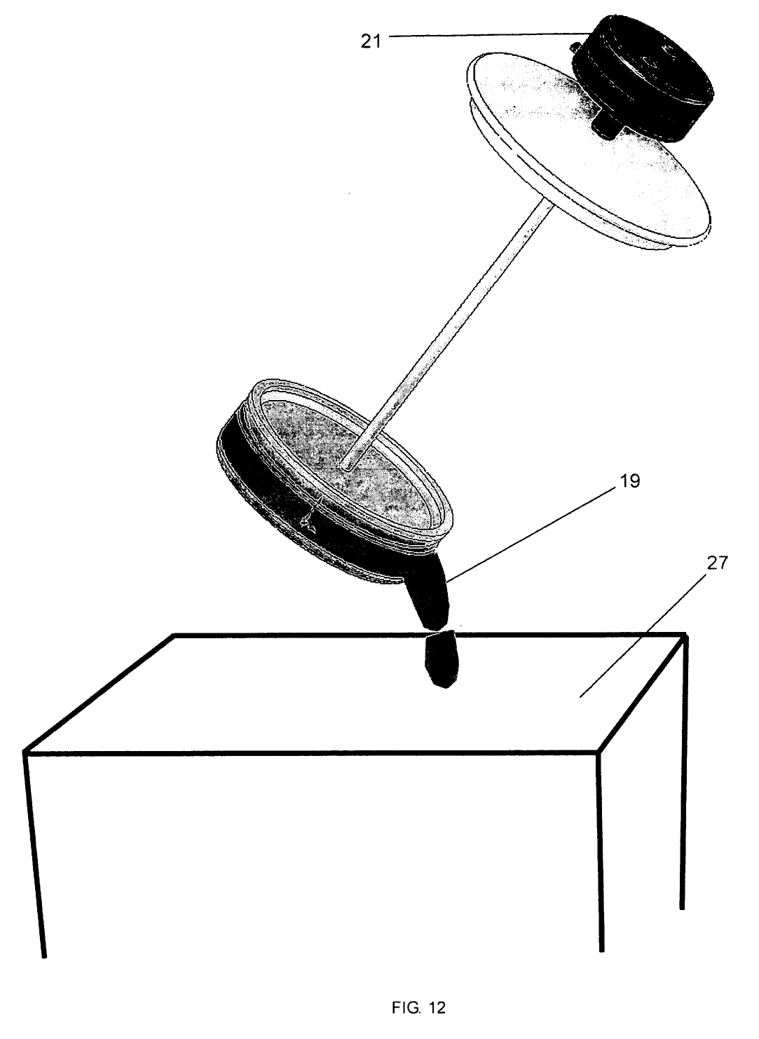

FIG. 12 is a perspective view of the invention showing the infusible material 19 being deposited into a suitable bin 27. The user simply holds onto the handle 21 and taps, shakes or otherwise moves the “sandwich” of infusible material until it is dislodged and falls into the bin 27. Note that at no time is the user required to handle the wet infusible material. Once the majority of the infusible material 19 has been deposited into a bin 27, the user can simply rinse off any residual infusible material 19 from the insert 16, plunger 13, and container 12.

### Reference Numerals

11 Beverage infusion making apparatus

12 Container

13 Plunger

14 Tube

15 Head

16 Insert

17 Shaft

18 Plate

19 Infusible material

20 Lid

21 Handle

22 Catch

23 Horizontal spring

24 Vertical spring

25 Button

26 Detents

27 Bin

28 Locking mechanism

### Operation

In operation, the insert 16 is placed into the container 12. Infusible material 19 is then introduced into the container 12, hot water is added into the container 12 and the mixture of water and infusible material 19 is allowed to steep for a sufficient period of time.

The plunger 13 which is rigidly affixed to the handle 21 is placed at the top of the container 12 and the end of the shaft 17 is aligned to the end of the tube 14 in the plunger 13. With the shaft 17 and tube 14 aligned, the handle 21 depressed, thereby inserting the plunger 13 into the container 12, while sliding the shaft 17 up through the tube 14. As the head 15 of the plunger 13 is pushed into the container, the infusible material 19 is directed downwards and becomes sandwiched between the upper face of the plate 18 and the downward face of the plunger head 15. The multiple detents 26 accommodate different amounts of infusible material and ensure that said infusible material 19 gets compacted and that the maximal amount of beverage is actually available for consumption. The upper edge of the interior wall of the container 12 may have a bevel, round or other feature to facilitate insertion of the insert 16 and plunger 13. Likewise, the end of the shaft 17, and entry hole of the tube 14 may be beveled, rounded or otherwise configured to make for easy insertion of the shaft 17 into the tube 14.

With the infusible material 19 contained between the head 15 and plate 18, the user is free to dispense the infusion beverage in the normal manner. When it is time to clean the invention, the user pulls up on the handle 21 to thereby extract the head 15, infusible material 19, and plate 18 “sandwich” from the container 12. Residual water is leached from the infusible material 19 and falls downward in the gap between the plate 18 and the interior wall of the container 12 as the elements are pulled upwards, further compacting the infusible material 19 and making it sufficiently cohesive.

With the infusible material 19 removed thusly, the user then holds the removed items by the handle 21 and tips the aforementioned “sandwich” over a suitable bin 27 to thereby dislodge and easily deposit the infusible material 19. Because the plate 18 is preferably smooth and solid without any protruding features, holes, or crevices, most of the infusible material 19 will easily be dislodged off into the bin 27. Any residual infusible material 19 on the insert 16, plunger 13, or on the inside of the container 12 can be quickly and easily rinsed off in a sink without risk of clogging (because there is such a small amount of infusible material 19 left—the vast majority of it will have been deposited in the bin 27).

The user then depresses the end of the catch 22 and thereby releases the shaft 17 from the locking mechanism 28 in the handle 21. They separate the insert 16 from the plunger 13 and the infusion process can begin again.

Alternately, the user may elect to remove the plunger 13, infusible material 19, and insert 16 “sandwich” by pulling up on the handle 21 prior to dispensing the beverage.

Although the present invention has been described with reference to preferred embodiments, workers skilled in the art will recognize that changes may be made in form and detail without departing from the spirit and scope of the invention. It is the applicant's intent that the invention claimed include any design variations which incorporate the combination of an insert having a generally planar plate form that is releasably secured to either the plunger, handle or lid of the infusion making apparatus. Furthermore, it will be apparent that the arrangement described herein can be used for other beverage infusions than coffee, for example, tea, herbal drinks or medicinal infusions.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A beverage making apparatus for infusible material and fluid, the apparatus comprising:
a container;
a plate receivable within the container proximate a bottom surface thereof;
a rod extending substantially vertically from the plate and secured therewith;
a plunger assembly shiftable from an upper position to a lower position to capture infusible material between the plunger assembly and the plate, the plunger assembly including an opening aligned with the rod such that the rod is received in the opening and releasably secured with the plunger assembly in the lower position.

2. An apparatus for infusing liquid with an infusible material, the apparatus comprising:
a container:
a plate receivable within the container proximate a bottom surface thereof;
an upstanding member secured with the plate;
a plunger assembly having an upper portion for manipulating the plunger assembly between and to upper and lower positions, the plunger assembly releasably securable with the upstanding member secured with the plate so that the plate and plunger may be removed from the container as a single unit, the plunger including a push-button release for releasing the upstanding member from the plunger assembly.
